(19) United States
(12) Patent Application Publication
(10) Pub. No.: US 2013/0212337 A1
(43) Pub. Date: Aug. 15, 2013

(54) EVALUATION SUPPORT METHOD AND EVALUATION SUPPORT APPARATUS

(71) Applicant: Fujitsu Limited, (US)

(72) Inventor: Tetsutaro MARUYAMA, Kawasaki (JP)

(21) Appl. No.: 13/705,291

(22) Filed: Dec. 5, 2012

(30) Foreign Application Priority Data
Feb. 13, 2012 (JP) 2012-028932

(51) Int. Cl. G06F 12/00

(52) U.S. Cl. CPC G06F 12/00
USPC 711/147

(57) ABSTRACT

An evaluation support method includes acquiring a first number of occurrences of accessing target data stored in a first storage apparatus per unit time, a second number of occurrences of accessing a second storage apparatus per unit time, and a predictive response time for accessing the second storage apparatus after the target data is transferred to the second storage apparatus; calculating, based on the first number of occurrences, the second number of occurrences, and the predictive response time, multiplicity that expresses the extent to which process time periods for accesses overlap when each access to the second storage apparatus after the target data is transferred is processed in parallel; and outputting the multiplicity.

### CROSS REFERENCE TO RELATED APPLICATIONS

This application is based upon and claims the benefit of priority of the prior Japanese Patent Application No. 2012-028932, filed on Feb. 13, 2012, the entire contents of which are incorporated herein by reference

### FIELD

The embodiments discussed herein are related to an evaluation support program, an evaluation support method and an evaluation support apparatus.

### BACKGROUND

As virtualization and cloud computing develop, the consolidation of servers and the incorporation of a server in the cloud computing architecture are promoted. It is expected that storage will also be consolidated. In the case of the consolidation of storage, multitenancy and quality of service (QoS) are required. Multitenancy is that data of one user is protected from another user, preventing the access by another user. QoS is that a certain level of communication quality is guaranteed.

When a user has her/his own hardware, the performance of storage depends on the hardware and is not much affected by other users. However, once storage is consolidated, multiple users utilize the same hardware. Therefore, the prediction or monitoring of the performance for each user or the control by means of software becomes important.

A few related arts are mentioned here. An information processing device receives commands from hosts and performs processes according to the commands. The command multiplicity for each host is dynamically determined and is controlled (see, for example, Japanese Laid-open Patent Publication No. 2008-226040). A ratio of time during which input/output groups use a disk apparatus is defined and the quanta during which input/output groups can use the disk apparatus continuously based on the time ratio (see, for example, Japanese Laid-open Patent Publication No. 2001-43032). Multiplicity of copy units is detected via a network and when the multiplicity is not sufficient, a copy request is sent to a storage device (see, for example, Japanese Laid-open Patent Publication No. 2003-223286).

However, there is a problem that it is difficult to evaluate the performance of storage when storage is consolidated and multiple users use the same hardware. For example, the addition of a system having an access characteristic similar to a currently running system could cause a problem that accesses concentrate in a certain time interval.

### SUMMARY

According to an aspect of an embodiment, an evaluation support method includes acquiring a first number of occurrences of accessing target data stored in a first storage apparatus per unit time, a second number of occurrences of accessing a second storage apparatus per unit time, and a predictive response time for accessing the second storage apparatus after the target data is transferred to the second storage apparatus; calculating, based on the first number of occurrences, the second number of occurrences, and the predictive response time, multiplicity that expresses the extent to which process time periods for accesses overlap when each access to the second storage apparatus after the target data is transferred is processed in parallel; and outputting the multiplicity.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of data transfer between storage apparatuses;

FIG. 2 is a diagram depicting an example of multiplicity calculation;

FIG. 3 is a diagram depicting an example of a configuration of a storage system 300;

FIG. 4 is a diagram depicting a hardware configuration of the evaluation support apparatus 301;

FIG. 5 is a diagram depicting a hardware configuration of the storage control apparatus 303;

FIG. 6 is a diagram depicting an example of a statistical information list;

FIG. 7 is a diagram depicting a functional configuration of the evaluation support apparatus 301;

FIG. 8 is a diagram depicting a process for an I/O request by a RAID controller Cᵢ;

FIG. 9 is a diagram depicting an example of measuring a capacity of a WRITE cache 802;

FIG. 10 is a diagram depicting a relationship between a volume size and a response time;

FIG. 11 is a diagram depicting the relationship between an IOPS and a response time;

FIG. 12 is a diagram depicting an example of a multiplicity table 1200;

FIG. 13 is a diagram depicting the relationship between multiplicity and IOPS;

FIG. 14 is a diagram depicting an exemplary screen on a display 409 displaying an output;

FIG. 15 is a flowchart depicting an evaluation support process of the evaluation support apparatus 301;

FIG. 16 is a flowchart depicting an evaluation support process of the evaluation support apparatus 301; and

FIG. 17 is a flowchart depicting a detailed multiplicity calculation process.

### DESCRIPTION OF EMBODIMENTS

Preferred embodiments of an evaluation support method, an evaluation support program, and an evaluation support apparatus will be explained with reference to the accompanying drawings.

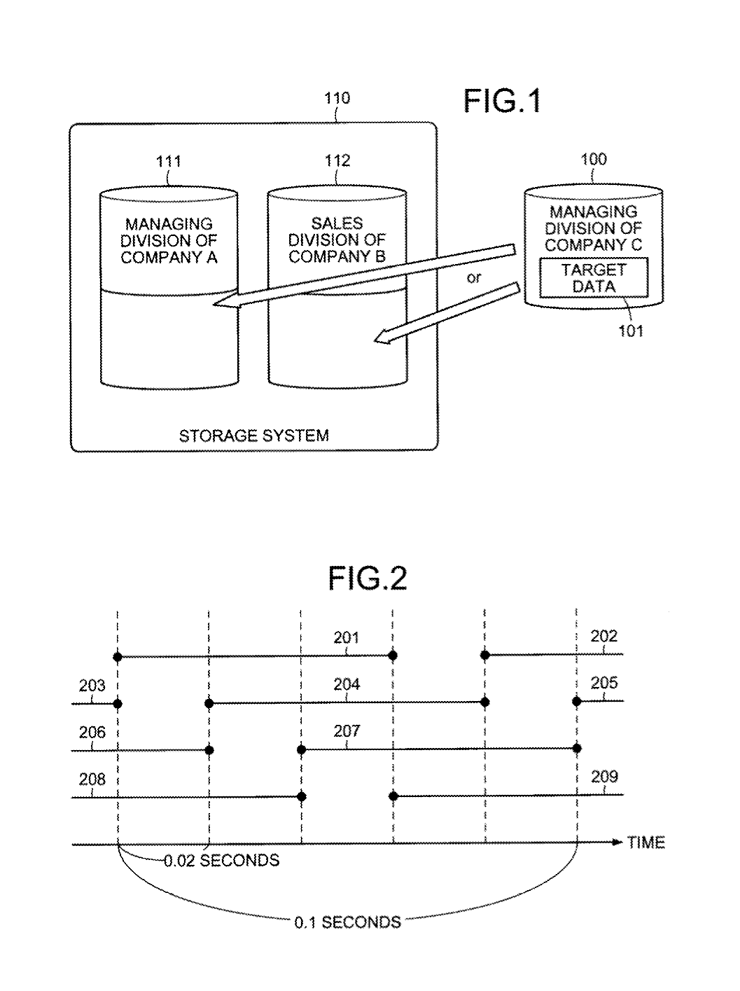

With reference to FIG. 1 and FIG. 2, multiplicity, an index for performance evaluation of a storage apparatus, will be explained.

FIG. 1 is a diagram depicting an example of data transfer between storage apparatuses. In FIG. 1, a first storage apparatus 100 stores target data 101. The target data 101 is used by a user, a managing division of company C. A storage system 110 is a system serving as a transfer destination and includes a second storage apparatus 111 and a third storage apparatus 112.

The second storage apparatus 111 and the third storage apparatus 112 are candidates for the data transfer destination. The second storage apparatus 111 stores data used by a user, a managing division of company A. The third storage apparatus 112 stores data used by a user, a sales division of company B.

When the target data 101 is transferred to the second storage apparatus 111 or the third storage apparatus 112, storage capacity sufficient to store the target data 101 is needed in the transfer destination. Here, it is assumed that the second storage apparatus 111 and the third storage apparatus 112 have a storage capacity sufficient to store the target data 101.

Access of the second storage apparatus 111 by the managing division of company A concentrates in the morning, during the nine o'clock hour. Access of the third storage apparatus 112 by the sales division of company B uniformly occurs during business hours (for example from 9 to 17 o'clock). Access of the target data 101 in the first storage apparatus 100 by the managing division of company C concentrates in the morning, during the nine o'clock hour.

In this case, if the target data 101 is transferred to the second storage apparatus 111 simply because sufficient storage capacity can be established, a concentration of access by users during the nine o'clock hour may significantly affect the performance of the second storage apparatus 111. Therefore, a determination of whether sufficient storage capacity can be established cannot serve as an indicator for the performance prediction of a storage apparatus to evaluate whether the storage capacity is large enough to store the target data 101.

Examples of an index that expresses load for a storage apparatus caused by accesses are Input Output Per Second (IOPS) and I/O size. IOPS indicates how many times an I/O request has been issued per one second. The I/O request is a WRITE request or a READ request. The I/O size indicates an average data amount input (write) into or output (read) from a storage apparatus when the I/O request is issued.

One example of an index that expresses the performance of a storage apparatus is a response time. However, the response time tends to increase as the I/O size increases. Thus, the response time cannot be a good indicator to know whether a storage apparatus can accommodate newly occurred load.

Another index that expresses the performance of a storage apparatus is a busy rate of a disk apparatus or redundant arrays of independent disks (RAID). The busy rate indicates a ratio of a processing time to a measuring time. However, it cannot be a good indicator to evaluate the performance of a storage apparatus that can simultaneously process multiple I/O requests.

In light of the above, this embodiment uses multiplicity as an indicator to evaluate the performance of a storage apparatus. Multiplicity expresses a degree of overlap of time intervals during which accesses are processed in a case where the accesses to the storage apparatus are processed in parallel.

FIG. 2 is a diagram depicting an example of multiplicity calculation. In FIG. 2, time intervals 201-209 during which I/O request are processed are depicted. A black circle on the left end of the time interval 201 indicates the timing at which an I/O request is received and a black circle on the right end indicates the timing at which a response to the I/O request is sent out.

Here, multiplicity is defined as the average of the number of time intervals overlapping per one second. The multiplicity is calculated by Equation (1) below.

Multiplicity=average IOPS×average response time (1)

In FIG. 2, one I/O request is issued every 0.02 seconds. Thus, average IOPS becomes 50. A response time to each I/O request is 0.06 seconds. Thus, the average response time is 0.06. From Equation (1), multiplicity becomes 3=50×0.06.

The multiplicity indicates the degree of overlap of time intervals. In other words, the multiplicity expresses the length of a queue that stores I/O requests. Therefore, larger multiplicity means that load for a storage apparatus is accumulating and the multiplicity is a good indicator to evaluate the performance of a storage apparatus.

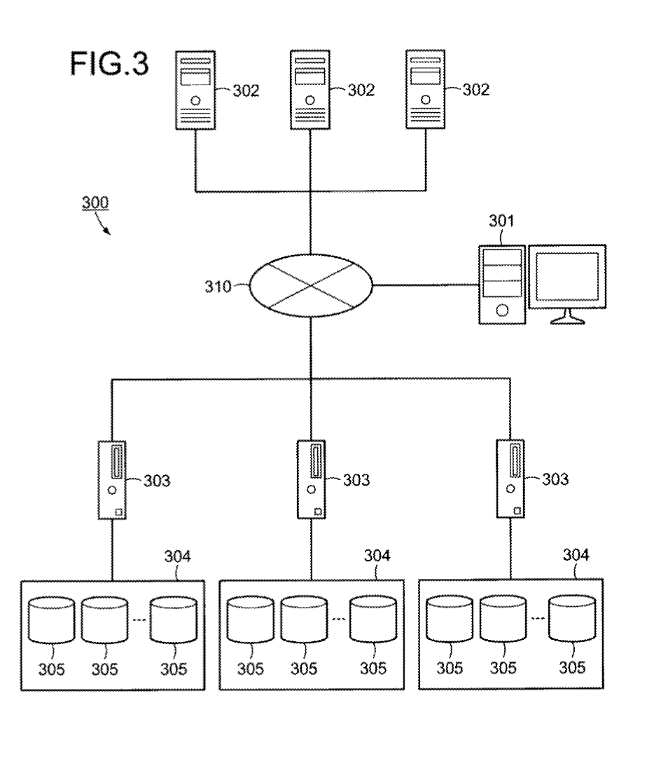

A storage system 300 according to embodiments will be explained. FIG. 3 is a diagram depicting an example of a configuration of the storage system 300. In FIG. 3, the storage system 300 includes an evaluation support apparatus 301, servers 302 (three servers in FIG. 3), and storage control apparatuses 303 (three apparatuses in FIG. 3).

The evaluation support apparatus 301, the servers 302, and the storage control apparatus 303 are connected each other via a wired or wireless network 310. The network 310 may be the Internet, a local area network (LAN), or a wide area network (WAN).

The evaluation support apparatus 301 is a computer that supports the performance evaluation of a storage apparatus 304. The server 302 is a computer that issues an I/O request to the storage apparatus 304. More specifically, the server 302 receives an I/O request from a client terminal (not shown) that a user of the storage system 300 manipulates, and sends the I/O request to the storage control apparatus 303.

The storage control apparatus 303 is a computer that controls the storage apparatus 304. More specifically, the storage control apparatus 303 receives an I/O request from the server 302 and controls the reading/writing of data from/to the storage apparatus 304.

The storage apparatus 304 stores data and includes medium 305 such as hard disk, optical disk, flash memory, and magnetic tape. The RAID technology that adopts data redundancy and enhances fault tolerance is applied to the storage apparatus 304.

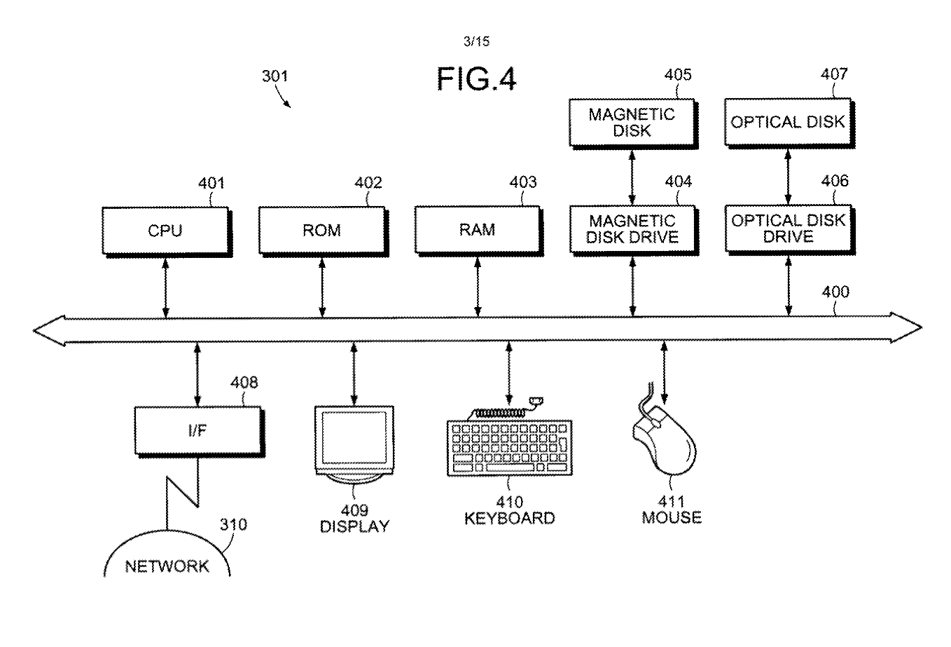

FIG. 4 is a diagram depicting a hardware configuration of the evaluation support apparatus 301. The evaluation support apparatus 301 includes a central processing unit (CPU) 401, a read-only memory (ROM) 402, a random access memory (RAM) 403, a magnetic disk drive 404, a magnetic disk 405, an optical disk drive 406, an optical disk 407, an interface (I/F) 408, a display 409, a keyboard 410, and a mouse 411. Elements 401 to 411 are connected through a bus 400 to each other.

The CPU 401 governs overall control of the evaluation support apparatus 401. The ROM 402 stores therein various programs such as a boot program. The RAM 403 is used as a work area of the CPU 401. The magnetic disk driver 404 controls the reading/writing of data from/to the magnetic disk 405 under the control of the CPU 401. The magnetic disk 405 stores the data written under the control of the magnetic disk drive 404.

The optical disk drive 406 controls the reading/writing of data from/to the optical disk 407 under the control of the CPU 401. The optical disk 407 stores the data written under the control of the optical disk drive 406. A computer reads the data stored in the optical disk 407.

The I/F 408 is connected to the network 310 via a communication line and is connected to other devices via the network 310. The I/F 408 governs the network 310 and the internal interface and controls the input/output of data to/from an external device. The I/F 408 may be a modem or a LAN adaptor.

The display 409 displays icons, cursors, tool boxes, or various data such as texts, images, and function information. For example, a CRT, a TFT liquid crystal display, a plasma display, etc., can be employed as the display 409.

The keyboard 410 includes, for example, keys for inputting letters, numerals, and various instructions and performs the input of data. Alternatively, a touch-panel-type input pad or numeric keypad, etc. may be adopted. The mouse 411 is used to move the cursor, select a region, or move and change the size of windows. A track ball or a joy stick may be adopted provided each respectively has a function similar to a pointing device.

The evaluation support apparatus 301 may further include a scanner and a printer. The server 302 in FIG. 3 can be realized by a similar hardware configuration as the evaluation support apparatus 301.

FIG. 5 is a diagram depicting a hardware configuration of the storage control apparatus 303. The storage control apparatus 303 include a CPU 501, a memory 502, an I/F 503, and a RAID controller 504. Elements 501-504 are connected through a bus 500 to each other.

The CPU 501 governs overall control of the storage control apparatus 303. The memory 502 includes, for example, a ROM, a RAM, and a flash ROM. The flash Rom may store programs for operating systems. The ROM may store application programs. The RAM may be used as a work area of the CPU 501.

The I/F 503 is connected to the network 310 via a communication line and also connected to other devices via the network 310. The I/F 503 governs the network 310 and the internal interface and controls the input/output of data to/from an external device. The I/F 503 may be a modem or a LAN adaptor.

The RAID controller 504 accesses the storage apparatus 304 under the control of the CPU 501. The storage control apparatus 303 may further include an input device such as a keyboard and a mouse, and an output device such as a display.

A detailed example of statistical information of the storage apparatus 304 is explained. The statistical information of the storage apparatus 304 is collected regularly, for example, every 30 seconds. The statistical information may be collected from volumes assigned to users.

A volume is unit for management in the storage apparatus 304. The volume may be a logical volume that is a group of hard disks or partitions acting as one virtual volume. With respect to a user newly entering the storage system 300, statistical information concerning the volume allocated to the user under the previous environment is collected.

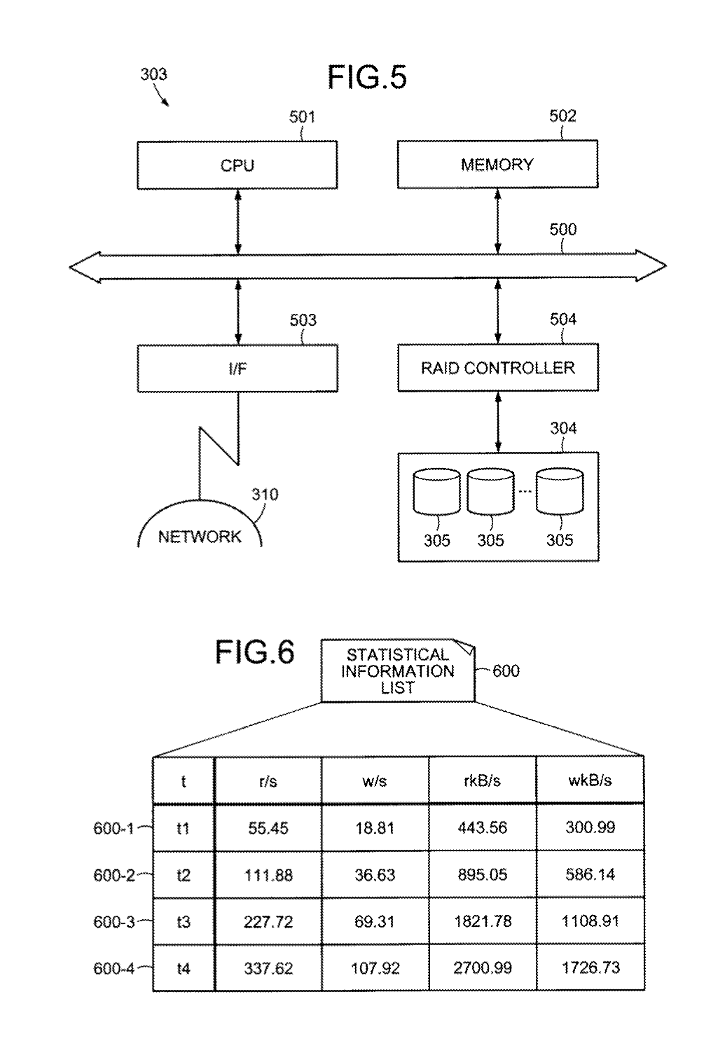

FIG. 6 is a diagram depicting an example of a statistical information list. A statistical information list 601 includes statistical information blocks 600-1 to 600-4. Each statistical information block 600-1 to 600-4 includes timing, r/s, w/s, rkB/s, and wkB/s.

The timing is, for example, time at which the statistical information 600-1 to 600-4 is measured. The r/s is the average of the number of times a READ I/O is issued per one second. The w/s is the average of the number of times a WRITE I/O is issued per one second. The rkB/s is the average of data size read per one second (unit: KB/sec) according to the READ I/O. The wkB/s is the average of data size written per one second (unit: KB/sec) according to the WRITE I/O.

The statistical information block 600-1 shows that at t1, r/s is 55.45 times, w/s is 18.81 times, rkB/s is 443.56 KB/sec, and wkB/s is 300.99 KB/sec.

The statistical information block 600-1 to 600-4 may further include information such as avgqu-sz, await, and %util. The avgqu-sz is the average length of a queue of I/O commands waiting for a response. The await is the average response time per an I/O (unit: msec). The %util is the ratio of time needed to issue I/Os during the measuring time (unit: %). The statistical information block 600-1 to 600-4 may include a volume size allocated to each volume.

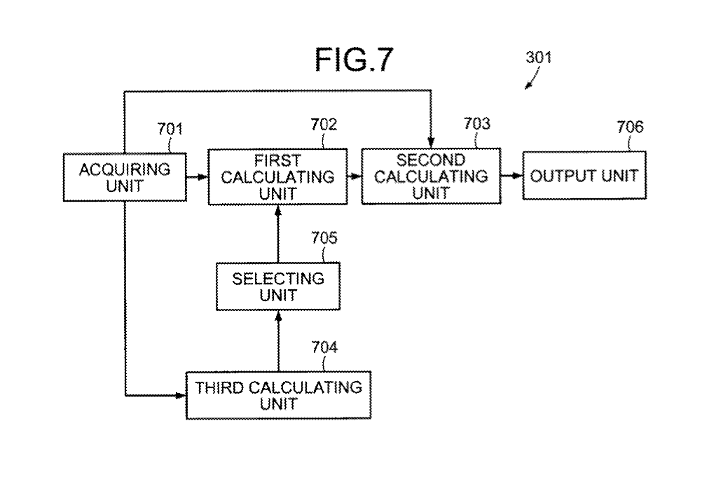

FIG. 7 is a diagram depicting a functional configuration of the evaluation support apparatus 301. The evaluation support apparatus 301 includes an acquiring unit 701, a first calculating unit 702, a second calculating unit 703, a third calculating unit 704, a selecting unit 705, and an output unit 706. These controlling functions (acquiring unit 701 to output unit 706) are realized by the execution by the CPU 401 of programs stored in storage devices such as the ROM 402, the RAM 403, the magnetic disk 405, and the optical disk 407 or by the I/F 408.

The acquiring unit 701 acquires a first number of occurrences, the number of times an I/O request for target data stored in the first storage apparatus is issued and a first I/O size, the size of data input to/output from the first storage apparatus. The target data is, for example, data used by a user who newly joins the storage system 300.

The first storage apparatus is a source of the target data transfer. The first storage apparatus may be a storage apparatus different from the storage apparatus 304 in the storage system 300 in FIG. 3 or a volume included in the storage apparatus different from the storage apparatus 304. The first storage apparatus may be one of the storage apparatuses 304 in the storage system 300 or a volume in the storage apparatus 304.

The I/O request for the first storage apparatus is a READ request or a WRITE request for the first storage apparatus. The first number of occurrences is the average IOPS of the READ request for the first storage apparatus and the average IOPS of the WRITE request for the first storage apparatus.

Data input to/output from the first storage apparatus is the data read out from the first storage apparatus and written into the first storage apparatus. The first I/O size is the average I/O size at the READ request for the first storage apparatus and the average I/O size at the WRITE request for the first storage apparatus.

The first number of occurrences and the first I/O size are calculated, for example, from the statistical information (see FIG. 6) of the first storage apparatus. The acquiring unit 701 acquires, via user operation of the keyboard 410 and the mouse 411, statistical information of the first storage apparatus during a unitary evaluation period. The acquiring unit 701 may acquire statistical information of the first storage apparatus from an external device via the network 310.

The evaluation period may be set freely. For example, the accumulated, entire evaluation period stretches from one o'clock to 24 o'clock of one day and a unitary evaluation period may be a certain time period within the entire evaluation period. In this case, statistical information during each time period is collected.

The entire evaluation period may range from the first week to the twelfth week of one year and a unitary evaluation period may be each week within the entire evaluation period. In this case, statistical information during each week is collected. The entire evaluation period may range from January to December of one year and a unitary evaluation period may be one month. In this case, statistical information during each month is collected.

The acquiring unit 701 calculates the average r/s during a unitary evaluation period based on the statistical information and yields the average IOPS of the READ request for the first storage apparatus during the unitary evaluation period. The acquiring unit 701 calculates the average w/s during a unitary evaluation period and yields the average IOPS of the WRITE request for the first storage apparatus during a unitary evaluation period.

The acquiring unit 701 calculates the average I/O size at the READ request during a unitary evaluation period by dividing rkB/s by r/s. The acquiring unit 701 calculates the average I/O size at the WRITE request during a unitary evaluation period by dividing wkB/s by w/s.

The acquiring unit 701 acquires a second number of occurrences, the number of times an I/O request for a second storage apparatus is issued and a second I/O size, the size of data input to/output from the second storage apparatus. The second storage apparatus is a destination of the target data transfer. The second storage apparatus may be one of the storage apparatuses 304 in the storage system 300.

The second storage apparatus is, for example, one of RAID groups constructed in the storage apparatus 304 in the storage system 300. The RAID group is a group of hard disks and etc. in the storage apparatus 304.

The I/O request for the second storage is a READ request and a WRITE request for the second storage apparatus. A second number of occurrences is the average IOPS of the READ request for the second storage apparatus and the average IOPS of the WRITE request for the second storage apparatus.

The data input to/output from the second storage apparatus is the data read out from the second storage apparatus and the data written into the second storage apparatus. The second I/O size is the average I/O size at the READ request for the second storage apparatus and the average I/O size at the WRITE request for the second storage apparatus.

The second number of occurrences and the second I/O size are calculated, for example, from the statistical information (see FIG. 6) of the second storage apparatus. The acquiring unit 701 acquires, via user input, statistical information of the second storage apparatus during a unitary evaluation period. The acquiring unit 701 may acquire statistical information of the second storage apparatus from an external device via the network 310.

The process of the calculation of the second number of occurrences and the second I/O size is identical to that of the first number of occurrences and the first I/O size and thus the detailed explanation thereof is omitted.

The first calculation unit 702 calculates an average response time of the I/O request for the second storage apparatus after the target data is transferred. The average response time is a predictive response time under the assumption that the target data is transferred to the second storage apparatus. For example, the first calculating unit 702 yields the average response time of the I/O request for the second storage apparatus based on the first number of occurrences, the first I/O size, the second number of occurrences, and the second I/O size.

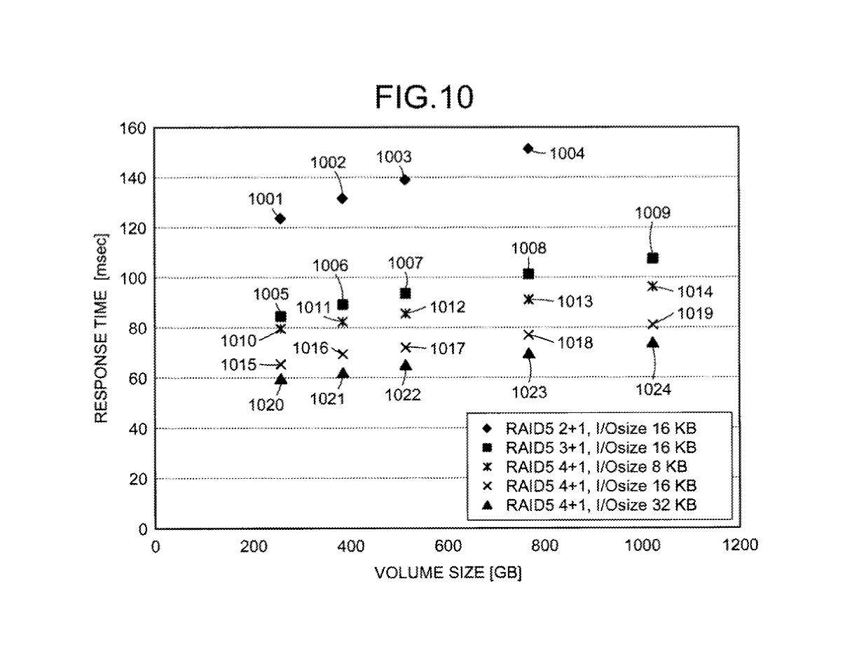

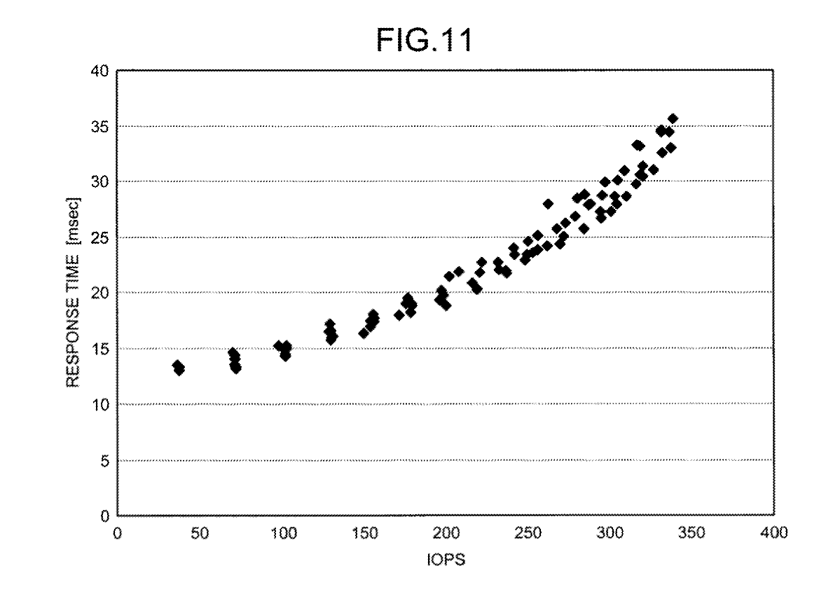

The average response time of the I/O request for a storage apparatus varies depending on the average I/O size and the average IOPS. The detailed explanation will be given later with reference to FIG. 10 and FIG. 11. The first calculating unit 702 calculates the average response time based on the average I/O size and the average IOPS of the second storage apparatus.

The average IOPS of the second storage apparatus is obtained from the sum of the first number of occurrences and the second number of occurrences. The average I/O size of the second storage apparatus is obtained by dividing the sum of the product of the first number of occurrences and the first I/O size and the product of the second number of occurrences and the second I/O size by the average IOPS of the second storage apparatus.

The average response time of the I/O request for a storage apparatus varies depending on the volume size of the storage apparatus. Thus the first calculating unit 702 may calculate the average response time based on the volume size of a new volume and the volume size of the existing volume in the second storage apparatus.

The volume size of the existing volume is a storage capacity of a storage area given to data in the second storage apparatus. The volume size of the new volume is a storage capacity of a storage area prepared for the target data.

The average response time is calculated for each unitary evaluation period based on the information (the first number of occurrences, the first I/O size, the second number of occurrences, and the second I/O size). The detailed process of the first calculating unit 702 will be explained later with reference to FIG. 10 and FIG. 11.

The second calculating unit 703 calculates multiplicity of the second storage apparatus based on the average response time and the first and second number of occurrences. The multiplicity indicates the degree of overlap of time intervals during which each I/O request is processed when each I/O request for the second storage apparatus is processed in parallel.

The second calculating unit 703 yields a third number of occurrences by summing the first and second number of occurrences. The third number of occurrences is, for example, the sum of the average IOPS of the READ request for the first storage apparatus and the average IOPS of the READ request for the second storage apparatus.

The third number of occurrences is, for example, the average IOPS of the WRITE request for the first storage apparatus and the average IOPS of the WRITE request for the second storage apparatus. In other words, the third number of occurrences expresses the average IOPS of the READ request for the second storage apparatus or the average IOPS of the WRITE request for the second storage apparatus.

The second calculating unit 703 yields multiplicity of the second storage apparatus in each unitary evaluation period by multiplying the average response time and the third number of occurrences using Equation (1). An example of the calculation of multiplicity will be given later.

The acquiring unit 701 acquires the amount of data per unit time input to the storage apparatus 304, a candidate for the transfer destination of the target data, and the amount of data per unit time input to the first storage apparatus.

The amount of data per unit time input to the storage apparatus 304 expresses the amount of write processes per unit time of the storage apparatus 304. The amount of data per unit time input to the first storage apparatus expresses the amount of write processes per unit time of the first storage apparatus. The amount of data per unit time input to the storage apparatus 304 or the first storage apparatus is called WRITE throughput.

The WRITE throughput is calculated based on the statistical information of the storage apparatus 304 or the first storage apparatus. For example, the acquiring unit 701 divides an accumulated I/O amount within the measuring time by the measuring time based on the statistical information of the storage apparatus 304 and yields the WRITE throughput of the storage apparatus 304. The measuring time can be set freely.

The third calculating unit 704 calculates, based on the acquired result, the amount of data per unit time input to each storage apparatus 304 after the target data is transferred. For example, the third calculating unit 704 adds WRITE throughput of the storage apparatus 304 and WRITE throughput of the first storage apparatus, yielding WRITE throughput of the storage apparatus after the data transfer.

The selecting unit 705 selects a second storage apparatus from among the storage apparatuses 304 based on the calculation result and the maximum data amount that can be input to the storage apparatus 304 per unit time. The calculation result is the amount of data per unit time input to the storage apparatus 304 after the data transfer.

The maximum data amount that can be input to the storage apparatus 304 per unit time expresses the maximum amount of write processes per unit time of the storage apparatus 304 and is called maximal WRITE throughput. The maximal WRITE throughput of each storage apparatus 304 is stored in a storage device such as the ROM 402, the RAM 403, the magnetic disk 405, and the optical disk 407.

The selecting unit 705 may select, as the second storage apparatus, a storage apparatus 304 whose WRITE throughput after the data transfer is less than the maximal WRITE throughput.

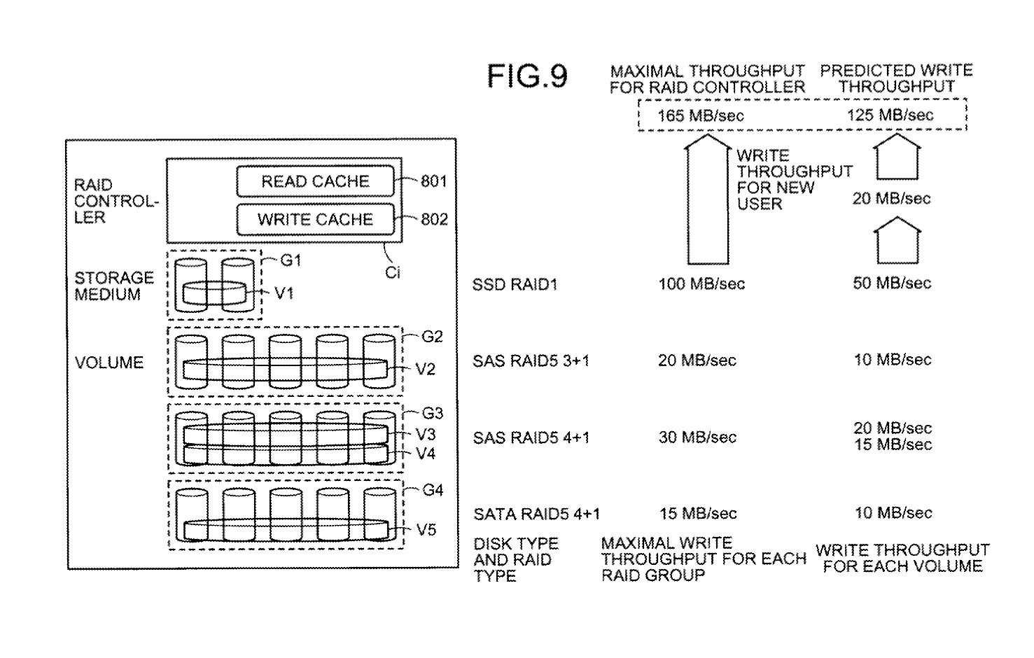

In this way, a storage apparatus 304 in which a prospective WRITE throughput caused by the data transfer is less than the maximal WRITE throughput can be selected. In other words, a storage apparatus 304 in which the prospective WRITE throughput after the data transfer exceeds the maximal WRITE throughput can be removed from a list of candidates of the data transfer destination. An example of the calculation of WRITE throughput will be given later with reference to FIG. 9.

The first calculating unit 702 may calculate an average response time of an I/O request for a selected second storage apparatus after the target data is transferred to the selected second storage apparatus. In this way, this scheme reduces useless calculations, avoiding the calculation of an average response time for a storage apparatus 304 in which the WRITE throughput after the data transfer exceeds the maximal WRITE throughput.

The output unit 706 outputs multiplicity of the second storage apparatus after the data transfer. The output unit 706 may output multiplicity in the second storage apparatus after the data transfer during each unitary evaluation period.

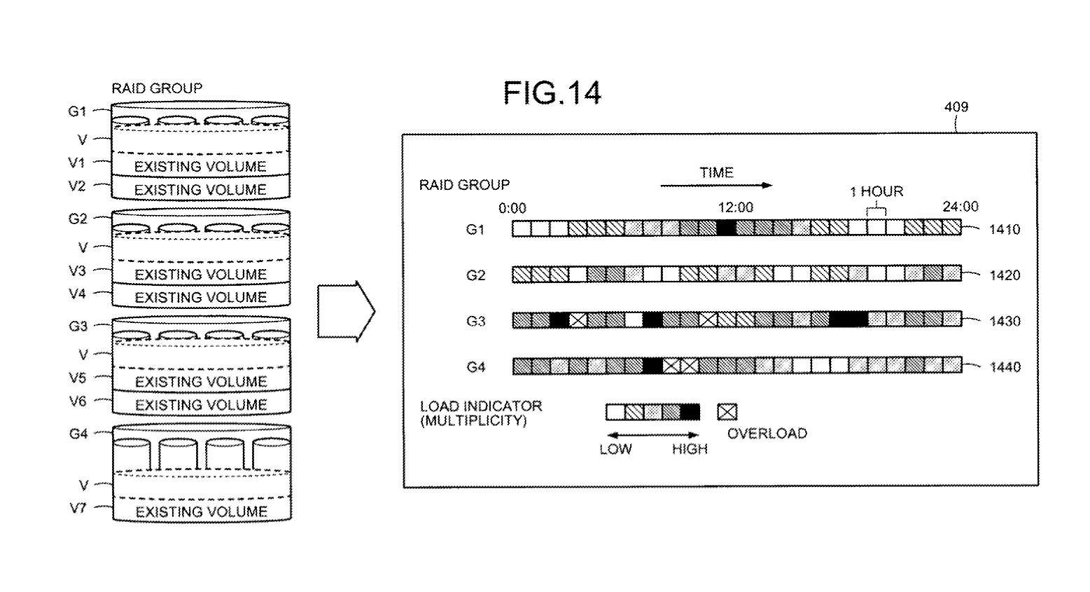

The output unit 706 may output a result on the display 409, to an external device from the I/F 408, or to a printer (not shown). The result may be stored in a storage area such as the RAM 403, the magnetic disk 405, and the optical disk 407. An example of the output result displayed on a screen will be given later with reference to FIG. 14.

In the example above, the first calculating unit 702 calculates the average response time of the I/O request for the second storage apparatus after the data transfer. However, the embodiment is not limited to this example. The acquiring unit 701 may acquire an average response time of the I/O request for the second storage apparatus after the data transfer where the average response time is predicted by a simulation using a response model.

In the explanation below, storage control apparatuses 303 may be mentioned as storage control apparatus SC₁ to SCₙ. An arbitrary storage control apparatus among SC₁ to SCₙ is written as storage control apparatus SCᵢ (i=1, 2, . . . , n). A RAID controller 504 in the storage control apparatus SCᵢ is written as RAID controller Cᵢ. A RAID group in the storage apparatus 304 that RAID controller Cᵢ accesses is written as RAID group G₁ to Gₘ. An arbitrary RAID group among G₁ to Gₘ is written as RAID group Gⱼ (j=1, 2, . . . , m). Evaluation periods are written as evaluation period T₁ to Tₚ. An arbitrary evaluation period among T₁ to Tₚ is written as evaluation period Tₚ (p=1, 2, . . . , P). Except as otherwise mentioned, the second storage apparatus is a RAID group Gⱼ in the storage apparatus 304 which the RAID controller Cᵢ accesses.

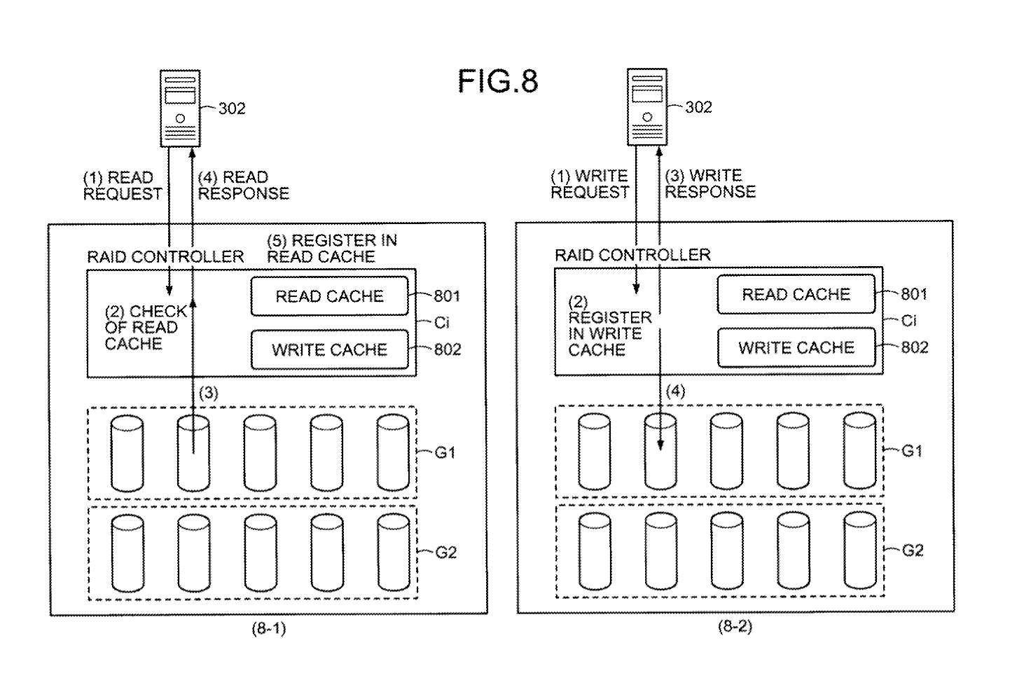

With reference to FIG. 8, an exemplary process of an I/O request for the RAID group Gⱼ by the RAID controller Cᵢ is explained.

FIG. 8 is a diagram depicting a process for an I/O request by the RAID controller Cᵢ. In 8-1, a process for a READ request performed by the RAID controller Cᵢ is depicted. This process is explained below.

(1) The RAID controller Cᵢ receives a READ request for a RAID group G₁ from the server 302. (2) The RAID controller Cᵢ determines whether a READ cache 801 stores data requested by the READ request. Here, it is assumed that the requested data is not present in the READ cache 801.

(3) The RAID controller Cᵢ reads out the requested data from the RAID group G₁. (4) The RAID controller Cᵢ transmits a READ response including the requested data to the sever 302 via the CPU 501.

(5) The RAID controller Cᵢ writes the data in the READ cache 801. Next time the same data is requested, the RAID controller Cᵢ reads the data from the READ cache 801 and returns the data to the server 302, improving the response performance.

In 8-2, a process for a WRITE request by the RAID controller Cᵢ is depicted. This process is explained below.

(1) The RAID controller Cᵢ receives a WRITE request for the RAID group G₁ from the server 302. (2) The RAID controller Cᵢ writes data requested by the WRITE request in a WRITE cache 802.

(3) The RAID controller Cᵢ transmits a WRITE response to the server 302 via the CPU 501. (4) The RAID controller Cᵢ reads out the written data from the WRITE cache 802 and writes the data in the RAID group G₁.

As can be seen, upon receipt of a WRITE request, the RAID controller Cᵢ does not directly access the hard disk but temporarily store the data in the WRITE cache 802. The data is sent to the hard disk asynchronous with the WRITE request.

In the case of a WRITE request, the RAID controller Cᵢ returns a WRITE response when the data is stored in the WRITE cache 802. Therefore, a response time for a WRITE request is approximately zero and does not influence multiplicity.

When the WRITE cache 802 is full of data, a WRITE response could be delayed until a storage area is released for the coming data.

As a result, a response time being about several msec soars into about several sec. Therefore, it becomes important to perceive the state of the WRITE cache 802.

The WRITE cache 802 is present in every RAID controller, not in every RAID group or volume. Because of this reason, the third calculating unit 702 checks the state of the WRITE cache 802 in every RAID controller Cᵢ before the calculation of multiplicity.

With reference to FIG. 9, the measuring of a capacity of the WRITE cache 802 by the third calculating unit 704 is explained.

FIG. 9 is a diagram depicting an example of measuring a capacity of the WRITE cache 802. RAID groups G₁ to G₄ that the RAID controller Cᵢ accesses are depicted in FIG. 9. A RAID group G₁ has a disk type of “solid state drive (SSD)” and a RAID type of “RAID1”. Volume V₁ is included in RAID group G₁.

A RAID group G₂ has a disk type of “serial attached SCSI (SAS)” and a RAID type of “RAID5 3+1”. Volume V₂ is included in RAID group G₂. A RAID group G₃ has a disk type of “SAS” and a RAID type of “RAID5 4+1”. Volumes V₃ and V₄ are included in a RAID group G₃. A RAID group G₄ has a disk type of “serial ATA (SATA)” and a RAID type of “RAID5 4+1”. Volume V₅ is included in a RAID group G₄.

The maximal. WRITE throughput for a RAID group G₁ is 100 MB/sec. The maximal WRITE throughput for a RAID group G₂ is 20 MB/sec. The maximal WRITE throughput for a RAID group G₃ is 30 MB/sec. The maximal WRITE throughput for a RAID group G₄ is 15 MB/sec.

The third calculating unit 704 adds the maximal WRITE throughputs of G₁ to G₄, yielding 165 MB/sec, the maximal WRITE throughput for RAID controller Cᵢ. The maximal WRITE throughput for each RAID group G₁ to G₄ are stored in a storage device such as the ROM 402, the RAM 403, the magnetic disk 405, and the optical disk 407.

WRITE throughput at volume V₁ is 50 MB/sec. WRITE throughput at volume V₂ is 10 MB/sec. WRITE throughput at volume V₃ is 20 MB/sec. WRITE throughput at volume V₄ is 15 MB/sec. WRITE throughput at volume V₅ is 10 MB/sec.

WRITE throughput of the first storage apparatus, a new user's WRITE throughput is 20 MB/sec. WRITE throughput of each volume V₁ to V₅ and of a new user are calculated from each piece of statistical information.

The third calculating unit 704 adds WRITE throughputs of each volume, yielding 125 MB/sec, prospective WRITE throughput of RAID controller Cᵢ after the data transfer.

The prospective WRITE throughput of RAID controller Cᵢ after the data transfer is less than the maximal WRITE throughput for RAID controller Cᵢ. Thus, the selecting unit 705 selects RAID groups G₁ to G₄ that RAID controller Cᵢ accesses deeming G₁ to G₄ as candidates of the data transfer destination.

As above, RAID groups that causes overflow in the WRITE cache 802 are eliminated from candidates of the data transfer destination and a wasteful calculation is reduced.

A process of calculating the average response time of a RAID group Gⱼ after the target data transfer is explained. With reference to FIG. 10 and FIG. 11, characteristics of a response time of a RAID group are explained.

FIG. 10 is a diagram depicting a relationship between a volume size and a response time. In FIG. 10, the horizontal axis denotes a volume size (GB) and the horizontal axis denotes a response time (msec). Dots 1001-1024 that expresses the relationship are plotted.

Dots 1001-1004 depict the relationship between a volume size and a response time in a RAID group having the RAID type of “RAID5 2+1” and the I/O size of “16 KB”. The I/O size indicates the average I/O size. Dots 1005-1009 depict the relationship between a volume size and a response time in a RAID group having the RAID type of “RAID5 3+1” and the I/O size of “16 KB”.

Dots 1010-1014 depict the relationship between a volume size and a response time in a RAID group having the RAID type of “RAID5 4+1” and the I/O size of “8 KB”. Dots 1015-1019 depict the relationship between a volume size and a response time in a RAID group of “RAID5 4+1” and the I/O size of “16 KB”. Dots 1020-1024 depict the relationship between a volume size and a response time in a RAID group having the RAID type of “RAID5 4+1” and the I/O size of “32 KB”.

As can be seen from FIG. 10, even if identical load (I/O size) is given to RAID groups, the response time increases as the volume size increases. In the case of RAID5, the response time increases inversely proportional to the rank of RAID. The response time increases inversely proportional to the I/O size.

The RAID rank indicates, for example, the number of hard disks where data is stored within a RAID group. This data does not include parity data. When RAID5 is made up of four hard disks and one parity disk, the total of five hard disks, the RAID rank is “4”.

FIG. 11 is a diagram depicting the relationship between the IOPS and the response time. In FIG. 11, the horizontal axis denotes the IOPS and the vertical axis denotes the response time (msec). Rhombus dots are plotted.

As can be seen from FIG. 11, the response time varies depending on the IOPS of a RAID group. The response time may be defined as an exponential function of the IOPS. The RAID group here is that having the RAID type of “RAID5 4+1” and the I/O size of “16 KB”.

In light of the characteristics of the response time, a response model is created and an average response time of a RAID group Gⱼ after the data transfer is calculated.

The first calculating unit 702 calculates, using Equation (2) below, maximal IOPS that a RAID group Gⱼ can process in response to a READ request. X denotes the maximal IOPS. C denotes a constant. r denotes an average I/O size (KB) of a RAID group Gⱼ in response to a READ request. R denotes the RAID rank. v denotes a ratio of allocated volumes in a RAID group Gⱼ.

$$X = C \times \frac{1}{r + 64} \times {R}^{0.55} \times {( v + 0.5 )}^{- 0.5} \qquad ( 2 )$$

Constant C takes different value at every storage apparatus 304 and is given beforehand based on an experiment. For example, when load of multiplicity=30 is put on a RAID group Gⱼ in the experiment, constant C under multiplicity=30 is acquired.

When constant C in Equation (2) above is acquired under multiplicity=30, the first calculating unit 702 calculates, according to Little's formula, a response time of a RAID group Gⱼ using Equation (3) below. W denotes an average response time (msec) with load of multiplicity=30 put on a RAID group Gⱼ.

W=30/X (3)

The first calculating unit 702 calculates coefficient α₁ using Equation (4) below. Equation (4) yields an average response time of a RAID group Gⱼ for only a READ process. More specifically, Equation (4) is a function expressing the average response time that incorporates the IOPS as an exponent and exponentially increases as the IOPS increases.

The first calculating unit 702 substitutes the average response time W obtained from Equation (3) into Equation (4) and yields coefficient α₁. L denotes an average response time of a hard disk when a READ response is received. S denotes an average seek time of a hard disk when a READ request is received.

W=e^{α1·X}+L+S×(v+0.5)^{0.5}+0.006r−1 (4)

The first calculating unit 702 calculates, using Equation (5) below, coefficient α with arbitrary load put on a RAID group Gⱼ. More specifically, the first calculating unit 702 substitutes coefficient α1 acquired from Equation (4) into Equation (5) below and yields coefficient α.

c denotes a READ mixing rate. The READ mixing rate is a value obtained by dividing the IOPS concerning READ by the sum of READ IOPS and WRITE TOPS (total IOPS). t denotes an I/O size ratio. The I/O size ratio is a value obtained by dividing the I/O size under WRITE by the I/O size uder READ. A denote a constant.

α=exp{A×t^{A}×(1−c)×e^{c}}/c^{1-c}×α (5)

The first calculating unit 702 calculates, using Equation (6) below, a response time W of a RAID group Gⱼ with arbitrary IOPS(x) given. More specifically, the first calculating unit 702 substitutes coefficient α obtained from Equation (5) into Equation (6) and yields the response time W.

W=e^{αX}+L+S×(v+0.5)^{0.5}+0.06r−1 (6)

Values substituted into Equations (2) to (6) are stored beforehand in a storage device such as the RAM 403, the magnetic disk 405, and the optical disk 407 or are calculated from statistical information of a RAID group Gⱼ.

The first calculating unit 702 performs the above processes and yields the response time W of a RAID group Gⱼ after the data transfer.

One example of performance prediction of a RAID group Gⱼ is explained. In this example, constant C=9400, disk size D=450 GB, average response time L of a hard disk at a READ request is equal to 2.0 msec, and an average seek time S of a hard disk at a READ request is equal to 3.4 msec.

It is further assumed that a RAID group Gⱼ has the disk type of SAS and the RAID type of RAID5 4+1. A RAID group Gⱼ includes volume V₁ having I TB. Volume V₁ belongs to a user U₁ who has been using the storage system 300.

In this case, the RAID rank R is 4. The volume size L₁ of V₁ is 1000 GB. The volume ratio v₁ allocated to volume V₁ is given by v₁=L₁/RD=0.556.

The evaluation period Tₚ is one hour from 10:00 to 11:00. The average I/O size at a READ request for volume V₁ during Tₚ is 32 KB and the IOPS is 150. The average I/O size at a WRITE request for volume V₁ during Tₚ is 64 KB and the IOPS is 50. In this case, the READ mixing ratio c₁ of V₁ is given by c₁=150/(150+50)=0.75. The I/O size ratio t₁ of V₁ is given by t₁=64/32=2.0.

It is assumed that a user U₂ who has been using 500 GB under the previous environment enters a RAID group Gⱼ. Hereinafter a volume in RAID group Gⱼ allocated to the user U₂ is called volume V₂. The volume size L₂ of volume V₂ is 500 GB. The volume ration v₂ of volume V₂ in RAID group Gⱼ is given by v₂=L₂/RD=0.278.

The average I/O size at a READ request for volume V₂ during Tₚ is 24 KB and the IOPS is 50. The average I/O size at a WRITE request for volume V₂ during Tₚ is 36 KB and the IOPS is 50. In this case, the READ mixing ration c₂ of volume V₂ is given by c₂=50/(50+50)=0.5. The I/O size ration t₂ of volume V₂ is given by t₂=36/24=1.5.

The first calculating unit 702 calculates a volume ration v when volume V₂ is added to a RAID group Gⱼ. The volume ration v is given by v=(L₁+L₂)/RD=0.833. The first calculating unit 702 calculates values below that indicates load of a RAID group Gⱼ with volume V₂ added.

READ IOPS: X_{R}=150+50=200

WRITE TOPS: X_{W}=50+50=100

IOPS of READ and WRITE: X_{T}=X_{R}+X_{W}=200+100=300

Average I/O size of READ: r=(32×150+24×50)/(150+50)=30 KB

READ mixing ratio: c=(150+50)/(150+50+50+50)=0.667

Average I/O size of WRITE: w=(64×50+36×50)/(50+50)=48 KB

I/O size ratio: t=w/r=48/30=1.6

The first calculating unit 702 calculates, using Equation (2), READ IOPS (X₃₀) under multiplicity=30. The first calculating unit 702 calculates, using Equation (3), an average response time W₃₀ concerning READ under multiplicity=30.

$${X}_{30} = C \frac{1}{r + 64} {{R}^{0.55} ( v + 0.5 )}^{- 0.5} = 1856.60$$

$${W}_{30} = 30 \frac{1000}{{X}_{30}} = 16.16 [ msec ]$$

The first calculating unit 702 calculates minimal response time Tₘᵢₙ and calculates, using Equation (4), coefficient α₁ under only a READ process.

$${T}_{m i n} = L + S \sqrt{v + 0.5} + 0.012 r = 6.29 [ msec ]$$

$${W}_{30} = {e}^{{α}_{1} {X}_{30}} + {T}_{m i n} - 1 -> {α}_{1} = \frac{log ( {W}_{30} - {T}_{m i n} + 1 )}{{X}_{30}} = 0.001285$$

The first calculating unit 702 calculates, using Equation (5), coefficient α_{c} with WRITE added. The first calculating unit 702 calculates, using Equation (6), an average response time W_{R} under a READ operation. The second calculating unit 703 calculates READ multiplicity N_{R} using the READ average response time W_{R}.

$${α}_{c} = \frac{exp ( 1.6 {t}^{0.16} ( 1 - c ) {e}^{c} )}{{c}^{1 - c}} {α}_{1} = 0.004508$$

$${W}_{R} = {e}^{{α}_{c} {X}_{R}} + {T}_{m i n} - 1 = 7.75 [ msec ]$$

$${N}_{R} = \frac{{X}_{R} {W}_{R}}{1000} = 1.55$$

The second calculating unit 703 calculates multiplicity N_{T} with READ and WRITE joined. When the selecting unit 705 has selected a RAID group Gⱼ, it is guaranteed that overflow does not occur in the WRITE cache 802. Thus, the average response time W_{W} of a WRITE operation is approximately zero. In this case, multiplicity N_{T} becomes equal to multiplicity N_{R}. W_{T} is the average response time with READ and WRITE joined.

$${W}_{T} = \frac{{X}_{R} {W}_{R} + {X}_{W} {W}_{W}}{{X}_{R} + {X}_{W }} = \frac{{X}_{R} {W}_{R}}{{X}_{R} + {X}_{W}}$$

$$\begin{matrix}{N}_{T} = \frac{{X}_{T} {W}_{T}}{1000} \\ = \frac{{X}_{T}}{1000} \frac{{X}_{R} {W}_{R}}{{X}_{R} + {X}_{W }} \\ = \frac{{X}_{R} + {X}_{W}}{1000} \frac{{X}_{R} {W}_{R}}{{X}_{R} + {X}_{W}} \\ = \frac{{X}_{R} {W}_{R}}{1000} \\ = {N}_{R}\end{matrix}$$

As a result, the average response time for a READ request is 7.75 msec and multiplicity is 1.55, which are the prospective performance and performance evaluation of a RAID group Gⱼ.

In the above example, the prediction is conducted based on the average over one hour during 10:00 to 11:00. Multiplicity of each time interval can be obtained by replacing READ IOPS (X_{P}), average I/O size of READ (r), READ mixing ratio (c), and I/O size ratio (t) with those of a different time interval. Instead of the average over one hour, the average over one day, one week, one minute, or one second may be used, enabling the performance evaluation based on various time scales.

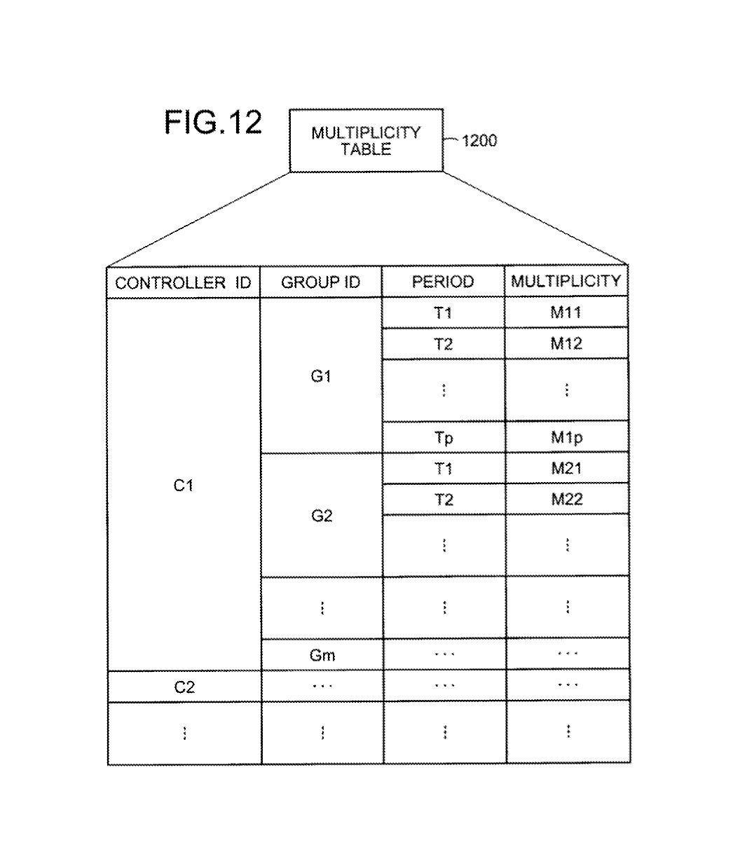

Multiplicity of a RAID group Gⱼ over Tₚ may be stored in a multiplicity table 1200 of FIG. 12. The multiplicity table 1200 is realized by, for example, a storage device such as the RAM 403, the magnetic disk 405, and the optical disk 407. The content of the multiplicity table 1200 is explained below.

In the above explanation, the ratio v is acquired from the calculation but the embodiments are not limited to this example. The ratio v may be constant (for example, v=0.5).

FIG. 12 is a diagram depicting an example of the multiplicity table 1200. The multiplicity table 1200 includes fields of controller ID, group ID, time interval, and multiplicity. In this way, multiplicity of each RAID group Gᵢ of each RAID controller Cᵢ over of a time interval Tₚ is stored.

The controller ID is an identifier for RAID controller Cᵢ. The group ID is an identifier for a RAID group Gⱼ. The time interval is an evaluation period Tₚ. Multiplicity is multiplicity during Tₚ. For example, multiplicity of a RAID group G₁ of RAID controller C₁ over the period Tₚ is M₁₁.

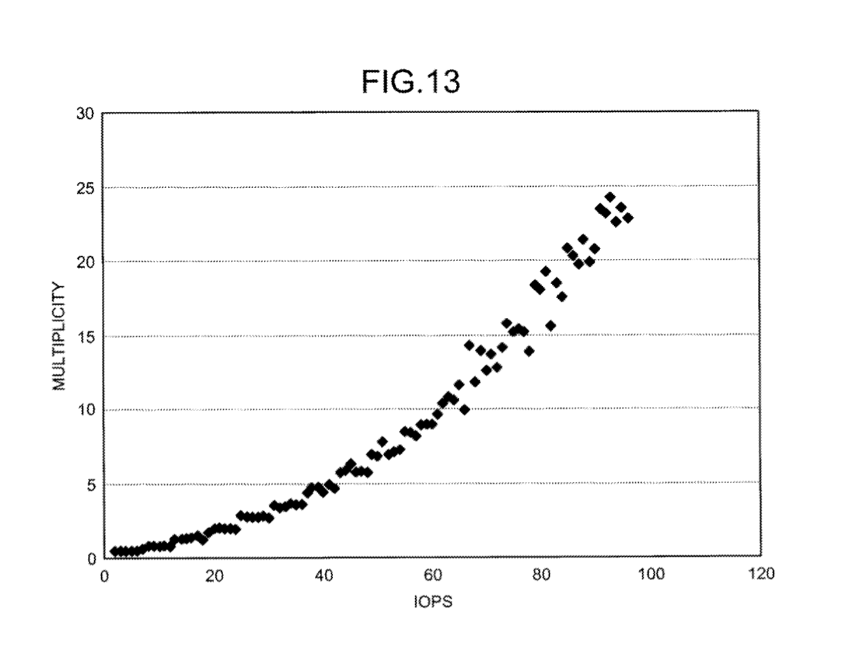

With reference to FIG. 13, the relationship between multiplicity of a RAID group Gⱼ over the interval Tₚ and IOPS is explained. The RAID group Gⱼ is of the RAID type “RAID5 4+1” and the I/O size 32 KB.

FIG. 13 is a diagram depicting the relationship between multiplicity and IOPS. In FIG. 13, the horizontal axis denotes IOPS and the vertical axis denotes multiplicity. As multiplicity of the RAID group Gⱼ increases, IOPS increases.

It is assumed that as the multiplicity exceeds about 30, an increasing rate of multiplicity of the RAID group Gⱼ becomes higher. In this case, a threshold for multiplicity is set, for example, to “20” being smaller than “30” so that the determination of excluding any RAID group Gⱼ whose multiplicity after the addition of the new user's volume exceeds the threshold can be made.

An example of an output from the output unit is explained. An exemplary screen displaying the output on the display 409 is explained. An exemplary screen explained below is generated by the evaluation support apparatus 301 with reference to the multiplicity table 1200 depicted in FIG. 12.

FIG. 14 is a diagram depicting an exemplary screen on the display 409 displaying an output. In FIG. 14, graphs 1410, 1420, 1430, and 1440 showing multiplicity of each time interval during 00:00 to 24:00 are depicted.

Squares in the graphs 1410, 1420, 1430, and 1440 represent multiplicity. Patterns in the squares express the intensity of multiplicity. Cross sign (×) in a square means that multiplicity in that time interval exceeds a given threshold (for example, exceeds a threshold of “20”).

The graph 1410 depicts multiplicity of the RAID group G₁ that RAID controller Cᵢ accesses. Multiplicity over each time interval indicates one when a new volume V is virtually added into the RAID group G₁ that includes existing volumes V₁ and V₂. According to the graph 1410, it can be seen that multiplicity during 11:00 to 12:00 is higher than others.

The graph 1420 depicts multiplicity of a RAID group G₂ that RAID controller Cᵢ accesses. Multiplicity over each time interval indicates one when a new volume V is virtually added into the RAID group Gⱼ that includes existing volumes V₃ and V₄. According to the graph 1420, there is no time interval with a black pattern and thus it can be said that no time interval with higher multiplicity compared with other RAID groups G₁, G₃, and G₄ is present.

The graph 1430 depicts multiplicity of a RAID group G₃ that RAID controller Cᵢ accesses. Multiplicity over each time interval indicates one when a new volume V is virtually added into the RAID group G₃ that includes existing volumes V₅ and V₆. According to the graph 1430, multiplicity during the time intervals of 03:00 to 04:00 and 10:00 to 11:00 exceed the threshold, meaning overloaded.

The graph 1440 depicts multiplicity of a RAID group G₄ that RAID controller Cᵢ accesses. Multiplicity over each time interval indicates one when a new volume V is virtually added into the RAID group G₄ that includes existing volumes V₇. According to the graph 1440, multiplicity during the time intervals of 08:00 to 09:00 and 09:00 to 10:00 exceed the threshold, meaning overloaded.

In light of the above, a manager of the storage system 300 can determine that it is suitable to add volume V into the RAID group G₄ as far as the capacity is concerned but predict that overload occurs during 08:00 to 10:00. As a result, the manager determines that the RAID group G₄ is not a suitable place to add a volume V.

The manager predicts that the RAID group G₃ can be overloaded during 03:00 to 04:00 and 10:00 to 11:00 and determines that the RAID group G₃ is not a suitable place to store a volume V. The manager perceives that the RAID group G₂ is recommended as a place to add a volume V because the maximal multiplicity of the RAID group G₂ is lower than that of the RAID group G₁.

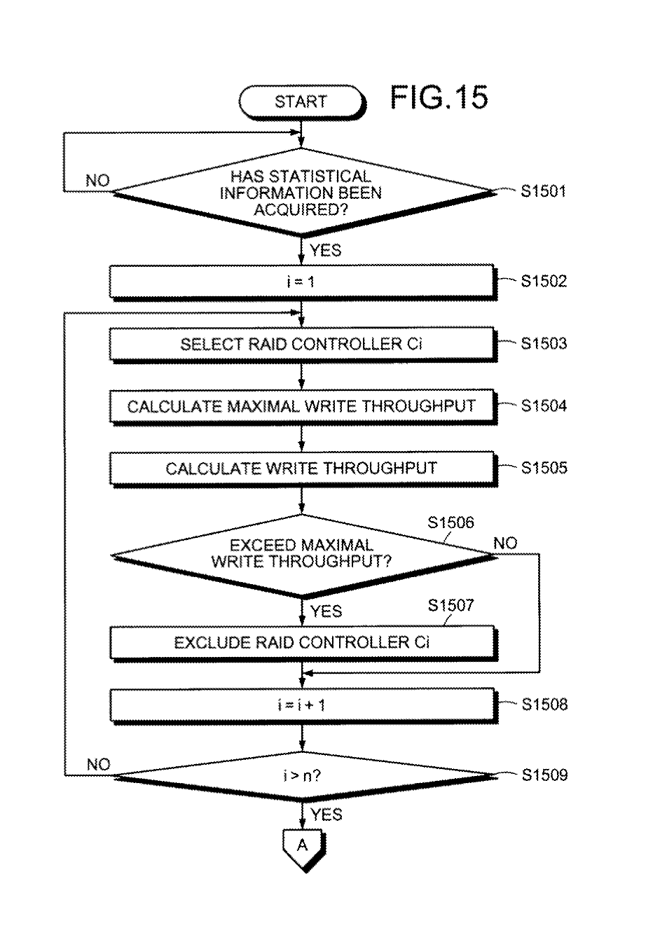

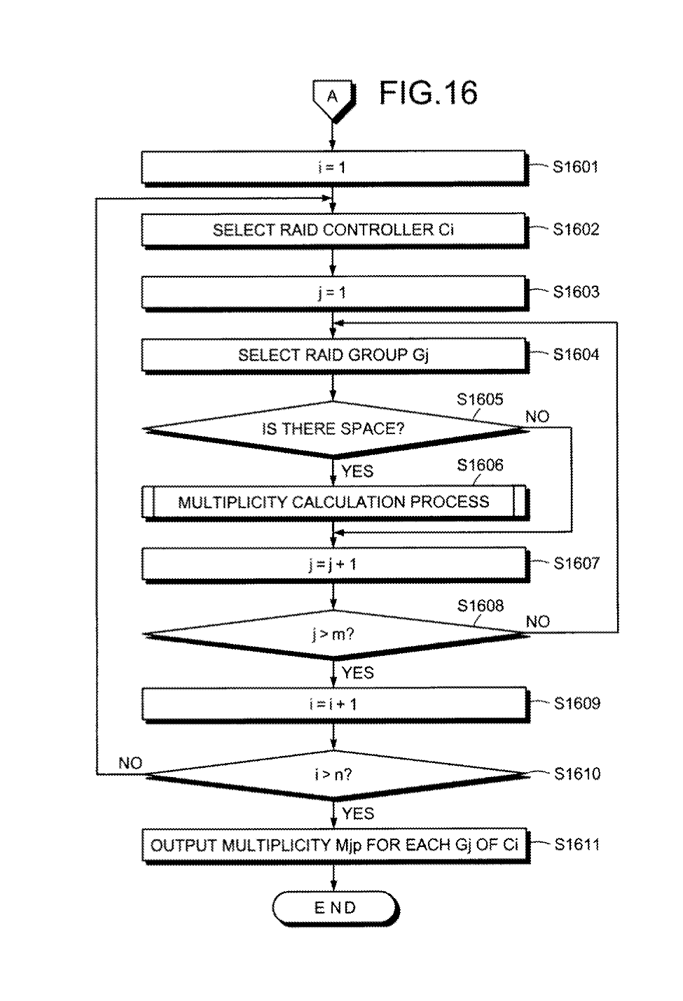

An evaluation support process of the evaluation support apparatus 301 is explained. FIG. 15 and FIG. 16 are flowcharts depicting the evaluation support process of the evaluation support apparatus 301.

The CPU 401 determines whether statistical information has been acquired (step S1501). The statistical information includes statistical information concerning the first storage apparatus (statistical information concerning a new volume) and statistical information concerning each storage apparatus 304 within the storage system 300.

The process waits until statistical information is acquired (step S1501: NO). When the statistical information is acquired (step S1501: YES), the CPU 401 sets of a RAID controller Cᵢ so that i=1 (step S1502). The CPU 401 selects the RAID controller Cᵢ from among RAID controller C₁ to Cₙ (step S1503).

The CPU 401 adds the maximal WRITE throughputs of each RAID group G₁ to Gₘ and computes the maximal WRITE throughput of the RAID controller Cᵢ (step S1504).

The CPU 401 adds a WRITE throughput of each volume and computes a prospective WRITE throughput of RAID controller Cᵢ after the data transfer (step S1505). The CPU 401 determines whether the computed WRITE throughput exceeds the maximal WRITE throughput (step S1506).

If the computed WRITE throughput does not exceed the maximal WRITE throughput (step S1506: NO), the process goes to step S1508. If the computed WRITE throughput exceeds the maximal WRITE throughput (step S1506: YES), the CPU 401 excludes the RAID controller Cᵢ from a candidate transfer destination (step S1507).

The CPU 401 increments i of RAID controller Cᵢ (step S1508) and determines whether i is larger than n (step S1509). If i is equal or less than n (step S1509: NO), the process returns to step S1503.

If i is larger than n (step S1509: YES), the process goes to step S1601 in FIG. 16. In the explanation below, the remaining RAID controllers except those excluded in step S1507 are expressed as “RAID controller C₁ to Cₙ”.

The CPU sets i of a RAID controller Cᵢ so that i=1 (step S1601). The CPU 401 selects a RAID controller Cᵢ from among RAID controllers Cᵢ to Cₙ (step S1602).

The CPU 401 sets j of a RAID group Gⱼ so that j=1 (step S1603). The CPU 401 selects a RAID group Gⱼ from among RAID groups G₁ to Gₘ (step S1604).

The CPU 401 determines whether the RAID group Gⱼ has a sufficient vacancy for a new volume (step S1605). The vacancy or the storage capacity necessary for adding a new volume of the RAID group Gⱼ is included in the statistical information or is calculated from the statistical information.

If there is no sufficient vacancy (step S1605: NO), the process goes to step S1607. If there is a sufficient vacancy (step S1605: YES), the CPU 401 performs a multiplicity calculation process (step S1606).

j of RAID group Gⱼ is incremented (step S1607). It is determined whether j is larger than m (step S1608). If j is equal to or less than m (step S1608: NO), the process goes to step S1604.

If j is larger than m (step S1608: YES), the CPU 401 increments i of RAID controller Cᵢ (step S1609) and it is determined whether i is larger than n (step S1610).

If i is equal to or less than n (step S1610: NO), the process returns to step S1602. If i is larger than n (step S1610: YES), the CPU 401 outputs multiplicity Mⱼₚ of each RAID group Gⱼ for each RAID controller Cᵢ during each time interval Tₚ (step S1611) and the process ends.

In this way, multiplicity Mⱼₚ, an indicator for the performance evaluation of each RAID group Gⱼ, is output. In the above explanation, multiplicity Mⱼₚ for each RAID group Gᵢ is output but the embodiments are not limited to this example. When multiplicity Mⱼₚ of RAID groups Gⱼ exceeds a predetermined threshold, the RAID groups may be excluded and be not presented to the manager of the storage system 300.

The multiplicity calculation process at step S1606 in FIG. 16 is explained.

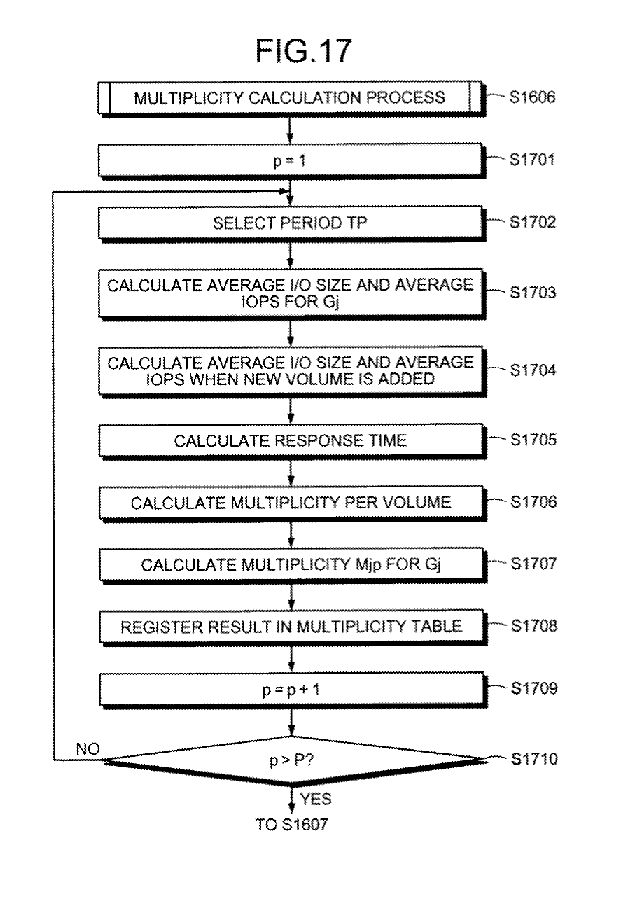

FIG. 17 is a flowchart depicting a detailed multiplicity calculation process. The CPU 401 sets p of an interval Tₚ so that p=1 (step S1701). The CPU 401 selects the interval Tₚ among intervals T₁ to Tₚ (step S1702).

The CPU 401 calculates an average I/O size and an average IOPS in a RAID group Gⱼ (step S1703). The CPU 401 calculates an average I/O size and an average IOPS when a new volume is added into the RAID group Gⱼ (step S1704).

The CPU 401 calculates a response time when a new volume is added into the RAID group Gⱼ (step S1705). The CPU 401 calculates multiplicity per volume including the new volume (step S1706). The CPU 401 adds multiplicity per volume and outputs multiplicity Mⱼₚ for the RAID group Gⱼ (step S1707).

The CPU 401 registers the multiplicity Mⱼₚ for the RAID group Gⱼ in the multiplicity table 1200 (step S1708). The CPU 401 increments p of the interval Tₚ (step S1709) and determines whether p is larger than P (step S1710).

If p is equal to or less than P (step 31710: NO), the process returns to step S1702. If p is larger than P (step S1710: YES), the process goes to step S1607 in FIG. 16.

In this way, multiplicity Mⱼₚ for the RAID group Gⱼ during the interval Tₚ, an indicator for the performance evaluation of the RAID group Gⱼ is calculated.

As explained above, according to the evaluation support apparatus 301, multiplicity of the RAID group Gⱼ after the data transfer is calculated based on the first and second number of occurrences and the average response time of the RAID group Gⱼ after the data transfer. Further, according to the evaluation support apparatus 301, multiplicity Mⱼₚ for the RAID group Gⱼ during the interval Tₚ after the data transfer is calculated based on the first and the second number of occurrences during the evaluation period Tₚ.

Accordingly, the performance of the RAID group Gⱼ during the interval Tₚ after the data transfer can be evaluated. The performance of the RAID group Gⱼ can be evaluated over various time intervals changing time unit of Tₚ (for example, one minute, one hour, one week, one month).

Multiplicity Mⱼₚ expresses the extent to which each process time intervals overlap when each I/O request is processed in parallel. Thus, the load of a RAID group Gⱼ is evaluated based on how much process time intervals for I/O requests overlap. In other words, multiplicity Mⱼₚ expresses the number of I/O requests in a queue and more I/O requests means larger load.

According to the evaluation support apparatus 301, based on the first number of occurrences, the first I/O size, the second number of occurrences, and the second I/O size, the average response time of a RAID group Gⱼ after the data transfer can be calculated. In this way, the average response time of a RAID group Gⱼ after the data transfer can be predicted based on the average I/O size and the average IOPS that influence the average response time.

Furthermore, according to the evaluation support apparatus 301, based on the volume size of the existing volumes in the RAID group Gⱼ and the volume size of a new volume, the average response time of the RAID group Gⱼ after the data transfer is calculated. As a result, the average response time of the RAID group Gⱼ after the data transfer is predicted based on a volume size that influences the average response time.

Furthermore, according to the evaluation support apparatus 301, using statistical information that can be collected with existing techniques, the average response time of the RAID group Gⱼ after the data transfer is predicted. Furthermore, based on simple calculations using Equations (2) to (6) above, the average response time of the RAID group Gⱼ after the data transfer is predicted.

As a result, the process time for the performance evaluation can be shortened in comparison with the prediction of the average response time using a simulation with an existing response model. Furthermore, a real time evaluation can be realized in consideration of load changing with time. When load of a RAID group suddenly increases, a RAID group having a sufficient capacity to take the load is quickly looked for.

Furthermore, according to the evaluation support apparatus 301, a RAID group whose WRITE throughput after the data transfer does not exceed the maximal WRITE throughput is selected as a candidate for the data transfer destination. As a result, any RAID groups that cause the overflow of the WRITE cache 802 are excluded from a candidate for the data transfer destination, thereby reducing wasteful processes related to the calculation of multiplicity.

The evaluation support method in the present embodiments can be implemented by a computer, such as a personal computer and a workstation, executing a program that is prepared in advance. The evaluation support program is recorded on a computer-readable recording medium such as a hard disk, a flexible disk, a CD-ROM, an MO, and a DVD, and is executed by being read out from the recording medium by a computer. The program can be distributed through a network such as the Internet.

According to one aspect of the embodiments, the performance evaluation of storage can be performed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An evaluation support method comprising:
acquiring
a first number of occurrences of accessing target data stored in a first storage apparatus per unit time,
a first data amount input to or output from the first storage apparatus when the target data is accessed,
a second number of occurrences of accessing a second storage apparatus per unit time,
a second data amount input to or output from the second storage apparatus when the second storage apparatus is accessed;
calculating, based on the first number of occurrences, the first data amount, the second number of occurrences, and the second data amount, a predictive response time for the second storage apparatus when the target data is transferred to the second storage apparatus;
calculating, based on the first number of occurrences, the second number of occurrence, and the predictive response time, multiplicity that expresses the extent to which process time periods for accesses overlap when each access to the second storage apparatus after the target data is transferred is processed in parallel; and
outputting the multiplicity.

2. The evaluation support method according to claim 1, further comprising:
acquiring a data amount per unit time input to the second storage apparatus and a data amount per unit time input to the first storage apparatus; and
calculating, based on the acquired result, a data amount per unit time that is input to the second storage apparatus after the target data is transferred,
wherein the calculating of the predictive response time includes calculating the predictive response time based on the first number of occurrences, the first data amount, the second number of occurrences, and the second data amount when the data amount per unit time input to the second storage apparatus after the target data is transferred does not exceed a maximal data amount that is acceptable by the second storage apparatus per unit time.

3. The evaluation support method according to claim 1, wherein
the acquiring includes acquiring the first number of occurrences, the first data amount, the second number of occurrences, and the second data amount during each of evaluation periods,
the calculating of the predictive response time includes calculating the predictive response time during each evaluation period based on the first number of occurrences, the first data amount, the second number of occurrences, and the second data amount during each evaluation period,
the calculating of the multiplicity includes calculating the multiplicity during each evaluation period based on the predictive response time, the first number of occurrences, and the second number of occurrences during each evaluation period, and
the outputting includes outputting the multiplicity during each evaluation period.

4. The evaluation support method according to claim 1, wherein
the calculating of the predictive response time includes calculating the predictive response time based on the first number of occurrences, the first data amount, the second number of occurrences, the second data amount, a capacity of a storage area given to data in the second storage apparatus, and a capacity of a storage area in the second storage apparatus prepared for the target data.

5. A non-transitory computer-readable recording medium storing therein a program that causes a computer to execute an evaluation support process, the evaluation support process comprising:
acquiring
a first number of occurrences of accessing target data stored in a first storage apparatus per unit time,
a first data amount input to or output from the first storage apparatus when the target data is accessed,
a second number of occurrences of accessing a second storage apparatus per unit time,
a second data amount input to or output from the second storage apparatus when the second storage apparatus is accessed;
calculating, based on the first number of occurrences, the first data amount, the second number of occurrences, and the second data amount, a predictive response time for the second storage apparatus when the target data is transferred to the second storage apparatus;
calculating, based on the first number of occurrences, the second number of occurrence, and the predictive response time, multiplicity that expresses the extent to which process time periods for accesses overlap when each access to the second storage apparatus after the target data is transferred is processed in parallel; and
outputting the multiplicity.

6. An evaluation support apparatus comprising:
an acquiring unit that acquires
a first number of occurrences of accessing target data stored in a first storage apparatus per unit time,
a first data amount input to or output from the first storage apparatus when the target data is accessed,
a second number of occurrences of accessing a second storage apparatus per unit time,
a second data amount input to or output from the second storage apparatus when the second storage apparatus is accessed;
a first calculating unit that calculates, based on the first number of occurrences, the first data amount, the second number of occurrences, and the second data amount, a predictive response time for the second storage apparatus when the target data is transferred to the second storage apparatus;
a second calculating unit that calculates, based on the first number of occurrences, the second number of occurrence, and the predictive response time, multiplicity that expresses the extent to which process time periods for accesses overlap when each access to the second storage apparatus after the target data is transferred is processed in parallel; and
an output unit that outputs the multiplicity.
